(19) United States
(12) Patent Application Publication
(10) Pub. No.: US 2008/0034037 A1
(43) Pub. Date: Feb. 7, 2008

(54) Sharing Graphical User Interface Output In Chat Environment

(76) Inventors: Jean-Pierre Ciudad, San Francisco, CA (US); Peter Westen, Mountain View, CA (US); Justin Wood, Sunnyvale, CA (US); Scott Forstall, Mountain View, CA (US); Marcel Van Os, San Francisco, CA (US); Michael V. Stein, San Jose, CA (US); Joe Engel, San Jose, CA (US); Steve Lemay, San Francisco, CA (US)

Correspondence Address: FISH & RICHARDSON P.C., PO BOX 1022, MINNEAPOLIS, MN, 55440-1022, US

(21) Appl. No.: 11/462,633

(22) Filed: Aug. 4, 2006

(51) Int. Cl. G06F 15/16

(52) U.S. Cl. 709/204

(57) ABSTRACT

Contents such as a GUI or application output can be shared in a chat environment. The user can choose to share own contents or request that contents be shared by another user (e.g., a chat partner). It can be possible to control the shared GUI or application from the recipient's location. The shared content can be integrated in content that is transmitted as part of a chat session.

### TECHNICAL FIELD

The disclosed implementations relate generally to sharing contents.

### BACKGROUND

Videoconferencing systems facilitate both audio and video communication among participants over a network. A conventional video conferencing system includes a near end and far end components. In a conventional videoconferencing system, image data associated with a near end user and the near end user's background is captured by a near end video camera or other capture device. The near end captured image data is transmitted to a far end receiver and displayed to a far end user. Similarly, the near end image data can be displayed on a local system (e.g., displayed on a near end display component) along with far end image data that has been captured by the far end system components.

### SUMMARY

The invention relates to sharing contents.

In a first implementation, a computer-implemented method for sharing content includes receiving at a first device a user input requesting that contents of a graphical user interface be shared. The user input is made in a chat environment including the first device. The method includes determining, in response to the user input, at least one chat identity of an entity registered in the chat environment. The method includes forwarding, using the determined chat identity, an invitation to the entity's device regarding sharing the contents of the graphical user interface, the invitation being generated from the user input.

Implementations can include any or all of the following features. If the entity accepts the invitation, the method can further include performing the sharing of the contents of the graphical user interface. The contents of the graphical user interface can be from the first device and the user input can request that the contents be shared with the entity, and performing the sharing can include forwarding the contents of the graphical user interface from the first device to the entity's device upon acceptance of the invitation. The contents of the graphical user interface can include at least one input control, and the method can further include performing an operation in or on the first device upon receiving a command from the entity's device, the command can be generated using the input control. The contents of the graphical user interface can originate from the entity's device and the user input can request that the entity share the contents, and performing the sharing can include receiving the contents of the graphical user interface from the entity's device upon acceptance of the invitation, and presenting the contents in the first device. The contents of the graphical user interface can include at least one input control, and the method can further include receiving an input in the first device made using the input control, and forwarding a command based on the input to the entity's device for performing an operation in or on the entity's device. The method can further include presenting in the first device an input control for selectively alternating the first device between presenting: A) the contents received from the entity's device; and B) graphical user contents not received from the entity's device. The entity can be identified, for forwarding the invitation, from a contact list associated with the chat environment. The entity can be currently participating in a chat session when the user input is received, and the identification can be based on the chat session. A user selection of the entity from the contact list can be made in connection with the user input.

In a second general aspect, a computer-implemented method for sharing content includes receiving, in a first device associated with a first entity, graphical user interface contents shared from a second device associated with a second entity. The first entity has been identified in a chat environment for receiving the shared graphical user interface contents. The method includes presenting the shared graphical user interface contents in the first device after the receipt. The method includes presenting, in the first device, a first input control for selectively alternating the first device between presenting: A) the shared graphical user interface contents; and B) graphical user contents not received from the second device.

Implementations can include any or all of the following features. The shared graphical user interface contents can be received after the first device accepts an invitation from the second device to receive the contents. The shared graphical user interface contents can be received after the second device accepts an invitation from the first device to share the contents. The contents can be shared during a chat session. The shared graphical user interface contents can include at least a second input control, and the method can further include receiving an input in the first device made using the second input control, and forwarding a command based on the input to the second device for performing an operation in or on the second device.

In a third general aspect, a computer program product is tangibly embodied in an information carrier and includes instructions that, when executed, generate on a display device a graphical user interface for sharing content. The graphical user interface includes a content area presenting shared graphical user interface contents. The graphical user interface is generated in a first device associated with a first entity and the graphical user interface contents being shared from a second device associated with a second entity. The first entity has been identified in a chat environment for receiving the shared graphical user interface contents. The graphical user interface includes a first input control for selectively alternating the first device between presenting in the content area: A) the shared graphical user interface contents; and B) graphical user contents not shared from the second device.

Implementations can include any or all of the following features. The shared graphical user interface contents can include at least a second input control, and an input can be made in the first device using the second input control for performing an operation in or on the second device.

### BRIEF DESCRIPTION OF THE DRAWINGS

FIG. 1 is a block diagram of an example architecture for sharing content or receiving shared content in a user interface.

FIG. 2 is a screen shot depicting an example of a desktop user interface with an open chat application.

FIG. 3 is a partial screen shot depicting a dialog box requesting a data sharing session from one user to another.

FIG. 4 is a partial screen shot depicting a dialog box for accepting or declining a sharing session from one user to another.

FIG. 5 is a screen shot depicting a dialog box notifying a user about the status of connecting to a sharing session.

FIG. 6 is a screen shot depicting an initial state of a shared desktop user interface.

FIG. 7 is a screen shot showing an example of initiating a sharing of application output with another user.

FIG. 8 is a screen shot depicting a user desktop receiving the shared application output described in FIG. 7.

FIG. 9 is a screen shot depicting a sharing session on the desktop user interface from which the sharing in FIG. 8 was initiated.

FIG. 10 is a screen shot showing an example of a first mode of display for sharing application output with another user.

FIG. 11 is a screen shot showing an example of a second mode of display for sharing application output with another user.

FIG. 12 is a screen shot showing an example of a third mode of display for sharing application output with another user.

FIG. 13 is a screen shot showing an example of a fourth mode of display for sharing application output with another user.

### DETAILED DESCRIPTION

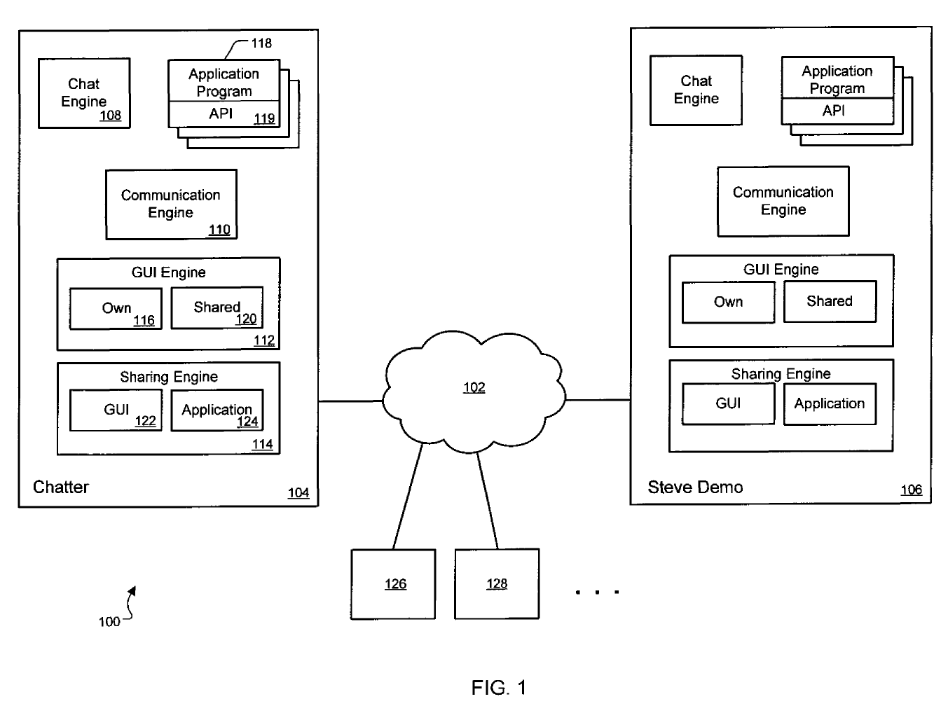

FIG. 1 is a block diagram of an example architecture 100 for sharing content or receiving shared content in a chat session user interface. The architecture 100 includes several systems for chatting, sharing content, or receiving shared content. In particular, data content, such as text, files, application data, video, audio, keystrokes, or operating system components can be shared in the chat session interface. Each system can include a unique chatting contacts list. Entities included in such lists can connect to others on other systems to chat or share content with one another over a network 102 (e.g., local area network, wireless network, Internet, intranet, etc.). For example, a system 104 can connect in a chatting application, and share data with a system 106 across a network 102.

The system 104 includes a chat engine 108 and a communication engine 110 for connecting over the network 102. The chat engine 108 can send and receive data content to and from the communication engine 110. When the chat engine is operating, it can generate a chat environment between two or more buddies, where one or more chat sessions can be initiated. The communication engine 110 can send data content over network 102 using a networking protocol or a protocol used for video chat, for example the user datagram protocol (UDP), between the system 104 (here labeled Chatter) and any other system, including the system 106 (here labeled Steve Demo), for example. Received data can be displayed in a recipient's user interface.

The system 104 also includes a graphical user interface (GUI) engine 112 and a sharing engine 114 for displaying and sharing data content, respectively. For example, the GUI engine 112 generates a screen that a chatter can view during a chat session. GUI engine 112 includes an own component 116 for generating the GUI essentially purely from Chatter's system 104. For example, the GUI can be generated from an application program 118 on system 104, or from the chat engine 108. Each application program 118 can include an application programming interface (API) 119. The system 104 can use API 119 techniques to enhance application programs with further functionality. For example, the API 119 can link several applications together for providing a single service on all linked applications. Particularly, the system 104 can use API techniques to enhance application programs with sharing functionality.

The API 119 API can be part of the Instant Message framework. The API can provide the developers with APIs to accomplish any or all of the application-related features described herein. Thus, it is possible to register with the Instant Message framework to receive callbacks, receive notifications when the conference starts, start the playback on demand, render frames in callbacks from Instant Message, provide audio in callbacks using Core Audio, or stop the presentation, to name just a few examples.

The GUI engine 112 also includes a shared component 120 for generating a GUI from data content that is shared by one or more buddies on other systems. For example, the shared component 120 can provide an output in Chatter's system of a GUI or an application window shared by a recipient system (e.g., Steve Demo). This sharing can be initiated during a chat session. In some implementations, the shared component 120 can display the shared data content in a separate GUI window or application that the system currently has open.

The sharing engine 114 included in the system 104 controls the data content that Chatter shares with other buddies. For example, Chatter's system 104 can share one or more applications with another chat partner through the network, and the sharing engine 114 then determines which applications are configured for sharing and performs the operations to forward the shared content. The sharing engine 114 includes a GUI component 122 for sharing a GUI with a chat partner. For example, the chat partner can see an image of Chatter's GUI on the chat partner's screen, optionally with the ability to control Chatter's computer through the presented GUI. In addition, the sharing engine 114 includes an application component 124 for Chatter to share an application output with a chat partner (e.g., via an API of the shared application). For example, Chatter's system 104 can share a video graphics application output with a chat partner and the application component 124 can use an API 119 to properly display the shared video.

The system 104 is a representative computer system in architecture 100. Several systems may exist in the architecture 100 and can contain equivalent components. For example, the chat partner Steve Demo (106) can have a similar system to system 104 with corresponding components. Systems 104, 106, 126, and 128 can all be connected to the network 102 and made available for chatting and sharing data.

While sharing data content and application output are described herein with respect to a personal computer 104, it should be apparent that the disclosed implementations can be incorporated in, or integrated with, any electronic device that has a visual user interface, including without limitation, portable and desktop computers, servers, electronics, media players, game devices, mobile phones, email devices, personal digital assistants (PDAs), embedded devices, televisions, telephones including mobile telephones, set top boxes, etc.

Systems and methods are provided for sharing data content and application output in a chat environment. The systems and methods can be stand alone, or otherwise integrated into a more comprehensive application. In the materials presented below, an integrated system and method for sharing data content is disclosed. However, one of ordinary skill in the art will recognize that the engines, methods, processes and the like that are described can themselves be an individual process or application, part of an operating system, a plug-in, an application or the like. In one implementation, the system and methods can be implemented as one or more plug-ins that are installed and run on a personal computer. The plug-ins are configured to interact with an operating system (e.g., MAC OS® X, WINDOWS XP, LINUX, etc.) and to perform the various functions, as described with respect to the Figures. A system and method for sharing data content can also be implemented as one or more software applications running on the computer. Such a system and method can be characterized as a framework or model that can be implemented on various platforms and/or networks (e.g., client/server networks, portable electronic devices, mobile phones, etc.), and/or embedded or bundled with one or more software applications (e.g., email, media player, browser, etc.).

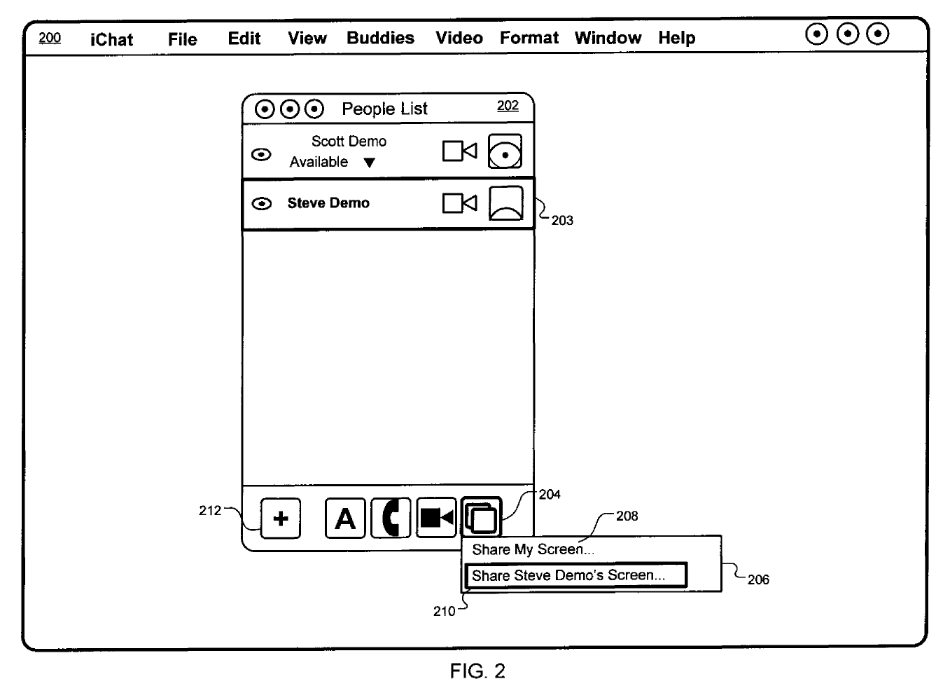

FIG. 2 is a screen shot depicting an example of a desktop user interface 200 with an open chat application 202. The desktop user interface 200 (also referred to herein as “desktop”) can be generated by Chatter's system 104. Chatter is here looking at the desktop 200 containing the chat application and this view can be generated by the GUI engine 112 using the own component 116. The chat application 202 is currently open and shows a “People” list 202 generated by the chat engine 108. For example, the chat application can be AOL Instant Messenger (AIM), ICQ, Jabber client for Mac OS X, or a chat application supported by iChat™ (available from Apple Computer in Cupertino, Calif.), to name a few examples.

As shown, Steve Demo 203 is one of the entities listed on the list 202. Here, Chatter wishes to initiate a chat session with Steve Demo and therefore selects Steve Demo 203 from the list. Once the Steve Demo 203 chat partner has been selected, Chatter here selects a share icon 204. The share icon 204 triggers a function that can dynamically create and display a drop down box 206 containing options pertaining to the selected user. For example, two options are shown in drop down box 206 for the user (Chatter) to select from. Here, Chatter can choose a first option 208 to “Share my Screen” or a second option 210 to “Share Steve Demo's Screen”. Chatter chooses the second option 210 to share Steve Demo's screen. Other examples of options that can be displayed here include sharing the output of one of Chatter's applications, or similarly sharing one of Steve Demo's applications.

Choosing to share another chat partner's screen activates the GUI engine 112 on Chatter's system 104 to initiate the shared component 120. The shared component 120 will seek to build a connection with the selected chat partner. Any form of connection available in the chat program can be used. For example, the shared component 120 can retrieve address information for Steve Demo's system 106 from the chat engine 108 to properly contact that system and subsequently receive shared data content. After retrieving an address, the shared component 120 sends an invitation to Steve Demo's system 106 using the communication engine 110. Because Chatter chose the option 210, the invitation to Steve Demo will ask for Steve Demo's screen (GUI) to be shared. In some implementations, no invitation is provided.

Alternatively, Chatter can choose the second option 208 to share his own screen with another chat partner, such as Steve Demo. If the “Share my screen” option 208 is selected, an invitation can be sent to Steve Demo inviting him to share Chatter's screen (or application output etc.). The sharing engine 114 in that example on Chatter's system 104 can send the invitation and address information to Steve Demo's communication engine, which, in turn, transfers the shared screen data to the GUI engine for display on Steve Demo's system 106.

An add user control 212 can be used to add one or more entities to the list 202. In some implementations, Chatter can have multiple chat sessions in progress at one time and share the contents of the chat sessions with any or all of his buddies.

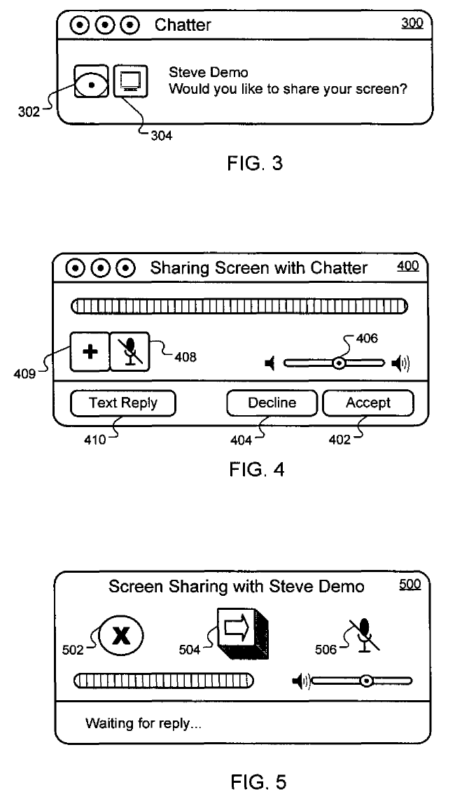

FIG. 3 is a partial screen shot depicting a dialog box 300 requesting a data sharing session from one user to another. In particular, dialog box 300 can be produced responsive to the invitation from Chatter to Steve Demo for sharing Steve Demo's screen with Chatter. The dialog box 300 specifically asks Steve Demo “Would you like to share your screen?” Chatter's screen icon 302 is shown along with Chatter's name. A screen icon is a user selected graphic that is another indication of the identity of a chat partner. Additionally, the icon 304 depicts that Chatter is here looking to view an application, a video or other data content rather than simply chatting text. Steve Demo can click on the dialog box 300 to receive further options or more information. Alternatively, if Steve Demo does not click on, or otherwise activate the dialog box 300, it can be closed after a set time, optionally with a notice sent to Chatter.

FIG. 4 is a partial screen shot depicting a dialog box 400 for enabling a data sharing session from one user to another. Specifically, this dialog box can appear when Steve Demo clicks the dialog box 300 (FIG. 3). The dialog box 400 displays a title of “Sharing Screen with Chatter” indicating that Chatter wishes to share the screen with the current chat partner (Steve Demo). In addition, an “Accept” button 402 and a “Decline” button 404 are included in the dialog 400. In this example, Steve Demo selects the “Accept” button 402 to accept the invitation and share his screen with Chatter. When the session is in progress, a control 406 can be used to adjust a volume level of incoming sound and control 408 can be used to adjust a microphone volume for outgoing sound. Additionally, an add user control 409 is included in the dialog box 400. The control 409 can be used to add one or more users to the chat session.

Accepting the invitation enables the GUI component of Steve Demo's sharing engine to start sharing content corresponding to Steve Demo's GUI. For example, Steve Demo's sharing component can alert Steve Demo's communication component to contact Chatter's communication engine 110 to begin sharing data. In some implementations, Steve Demo's communication engine could consult Steve Demo's chat engine to obtain Chatter's address. In other implementations, Chatter's address can be included in Chatter's invitation.

Steve Demo can otherwise choose to decline the invitation and deny access to his desktop for the other chat partner (Chatter). If the “Decline” button 404 were selected, Steve Demo's GUI component could have instructed his sharing component to respond with a rejection to Chatter. In the case of a decline, the dialog box 400 can disappear and Steve Demo's system can return to a previous application. When Steve Demo declines to share his screen, Chatter can receive a dialog box message indicating that the invitation has been declined. In some implementations, a user can send a text reply to the inviter regarding an acceptance or a decline using a “Text Reply” button 410. Text replies can be transmitted at the same time as the acceptance or decline is sent, for example.

A dialog box 500 can be displayed in Chatter's system 104. FIG. 5 is a screen shot of the dialog box 500 notifying Chatter about the status of connecting to a data sharing session with Steve Demo. At this point, Steve Demo has not yet accepted or declined the invitation, and Chatter has received a status dialog box 500, and is awaiting a response from Steve Demo. The dialog box 500 shows a “Waiting for reply . . . ” message on system 104 (Chatter). The dialog box 500 includes a terminate request icon 502, a toggle icon 504, and a microphone off icon 506. Chatter can select the terminate request icon 502 to terminate the sent invitation when a sharing session is in progress. Chatter can select a toggle icon 504 to toggle the output shown in the shared session. For example, the current state of the icon 504 (an arrow pointing to the right), can indicate that Chatter is viewing content from his own system (i.e., not something that has been received from another chat partner). This state can correspond to the own component 116 being active in the GUI engine 112 on Chatter's system. In contrast, another state of the icon 504 (such as an arrow pointing to the left) can indicate that Chatter is viewing content that has been received from a chat partner. This state, in turn, can correspond to the shared component 120 being active in the GUI engine 112 on Chatter's system. In addition, once the chat session is in progress, microphone and volume options can be configured before the session begins by selecting the microphone off icon 506. Other options are possible.

Here, Steve Demo has accepted Chatter's invitation. With reference again briefly to FIG. 1, as Chatter waits for the screen sharing to commence, Steve Demo's GUI information is transmitted over the network 102. The GUI information arrives in Chatter's shared component located in the GUI engine. The shared component invokes the GUI engine to switch from his “own” display to his “shared” display. Thus, Steve Demo's GUI is shown in Chatter's screen.

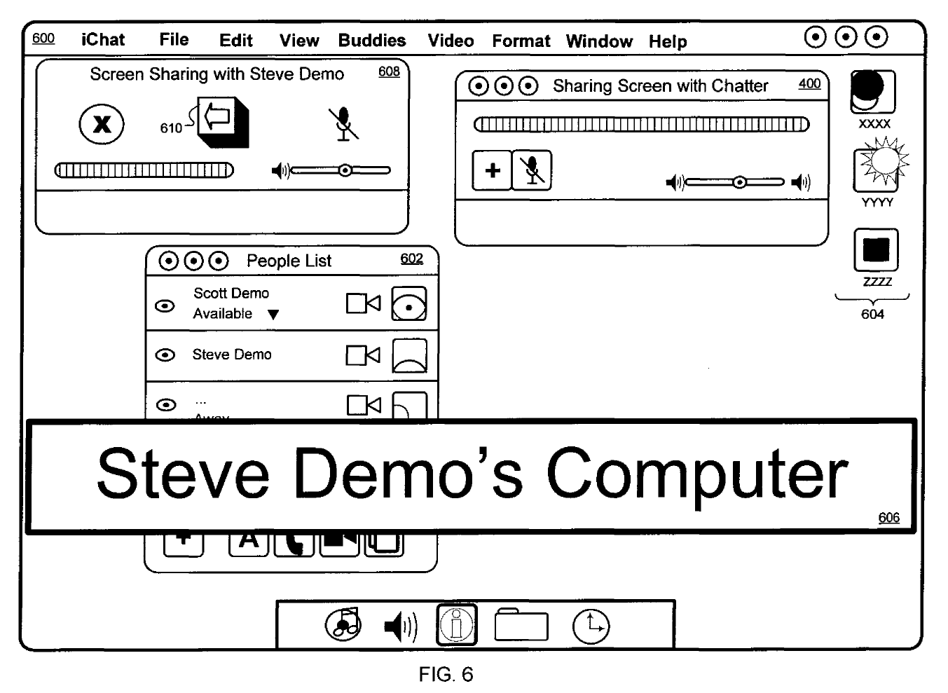

FIG. 6 is a screen shot depicting one possible initial state of Chatter's shared desktop user interface 600. Here, Steve Demo's menu bar (from an iChat™ program), people list 602, and icons 604 are all shown in the desktop 600. A “Sharing Screen with Chatter” dialog box 400, from Steve Demo's GUI, is also visible. The “Sharing Screen with Chatter” dialog box 400 is leftover from the initial invitation received from Chatter and can remain as long as the sharing continues. In some implementations, the leftover dialog box 400 can disappear as time elapses or upon user interaction with the desktop 600. In other implementations, the shared desktop is shown until one of the users sharing the screen changes the screen. For example, Steve Demo can choose to close the dialog box 400 some time into the shared session and this could end the sharing session.

Upon connection, a banner 606 can be displayed alerting Chatter that this is Steve Demo's GUI on display in desktop 600. The banner 606 can be animated to, for example, disappear or roll away as time elapses or upon user interaction. The initial banner 606 can be a useful indicator to avoid confusion when Steve Demo's GUI is displayed in full screen mode on a chat partner's computer system.

Similarly, a notification to Steve Demo can be generated on his computer. For example, the text “Sharing with Chatter . . . ” can be displayed. In one implementation, the text is scrolled from right o left in the menu bar of Steve Demo's screen at regular intervals.

A screen sharing dialog box 608 is shown indicating that a screen is being shared with Steve Demo. The dialog box 608 is generated by Chatter's GUI engine 112 and is similar to the dialog box 500 shown in FIG. 5. Thus, unlike other contents currently in the desktop 600, the dialog box 608 is here not received from Steve Demo's system. Note that a toggle icon 610 has turned in the opposite direction than the corresponding icon in the dialog box 500. The direction change can indicate that Chatter is currently viewing Steve Demo's GUI in the desktop 600 this time and not his own. Chatter can use the icon 610 to toggle between his own screen contents and, in this case, Steve Demo's. When Chatter has viewed his own contents and returns to viewing Steve Demo's, for example using the icon 610, the banner 606 can again be displayed. Each time the toggle icon 610 is selected, the view can change to another chat partner's system. If more than two buddies are currently sharing contents in the chat environment, the icon 610 can have more than two states to allow selection of input from any of the several sources.

Selecting the toggle icon 610 can change the displayed screen to Chatter's GUI and if selected again, can change the screen back to Steve Demo's GUI. In Chatter's system 104, this is essentially switching from displaying data from the Chatter's own component 116 (e.g., after toggle, Chatter's system is shown) and the shared component 120 (e.g., after toggling again, Steve Demo's system is shown). As described in FIG. 5, controls can be available in the dialog 608 for closing out the sharing sessions or modifying volume and microphone controls.

In some implementations, the icon 610 can also be used for one or more other functions. For example, content can be forwarded to another entity's device by dragging the content (e.g., a file) onto the icon. This causes the local system to transfer the file to the other entity. In one implementation, this is done by the application component 124 identifying the content portion that is being dragged and sending it to the other device.

In addition to viewing Steve Demo's GUI, Chatter can also control Steve Demo's GUI in one implementation. For example, Chatter can control Steve Demo's GUI by making a modification to an application shown in the GUI, such as through a keystroke, mouse click or other user input. In some implementations, not all inputs are transferred when this control feature is in operation. For example, some keystrokes or other inputs can be reserved for controlling the local machine, such as to perform a force-quit operation.

More specifically, when a keystroke is to be forwarded, Chatter's GUI engine 112 can receive the keystroke from Chatter's system 104, and transfer that keystroke to Chatter's communication engine 110. Communication engine 110 can transmit the keystroke or signal to Steve Demo's communication engine. Steve Demo's communication engine can take the received keystroke or signal and send it to an API in Steve Demo's system for the application program Chatter modified. For example, if Chatter modified information for a chat partner in the chat application 602 on Steve Demo's screen, the API connects to the chat application 602 that contains the people list and makes the intended modification (e.g., the information change for the chat partner).

It was mentioned above that the entire GUI contents is not the only content that can be shared in a chat environment. Rather, the output of any or all application programs can be selectively shared, as another example. Such application programs include the Quicktime Player, Keynote and iPhoto products that are available from Apple Computer, to name a few examples.

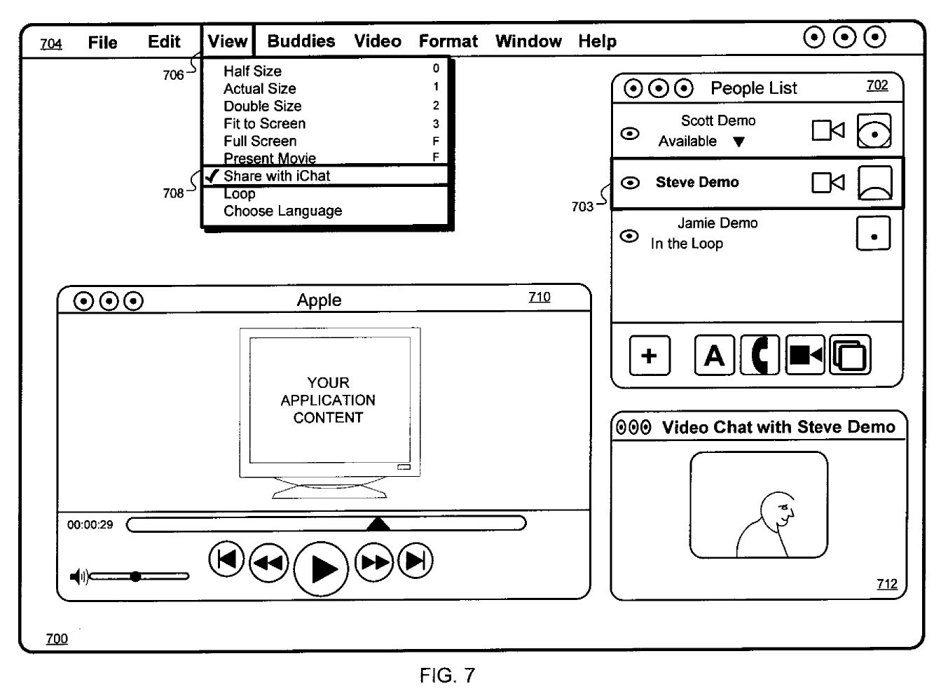

FIG. 7 is a screen shot showing an example of initiating the sharing of application output with another user. Specifically, the user “Chatter” is again looking at his screen. The screen can be generated by GUI engine 112 and display content from Chatter's own component 116. Here, the desktop 700 includes a chat application 702, such as iChat™, that contains a people list generated by the chat engine 108. The desktop 700 here also includes an application specific menu bar 704 associated with an application program 710. Chatter has selected Steve Demo 703 from the list in the chat application 702 and is currently using a view menu 706 from the menu bar 704. The application menu has been provided with a “Share with iChat” command 708. This allows a user to initiate a sharing session through iChat from the application program. For example, the command 708 can be provided through an API for the application 710. The application 710 can be an audio or video application, such as iTunes, Media Player, Real Player, or another content generating or playing application, to name a few examples. Chatter wishes to share the output of the application program 710 and thus, he selects the “Share with iChat” command 708 to share the output of application 710 with the selected Steve Demo entity 703.

Selecting the “Share with iChat” command 708 can invoke the sharing engine 114 on Chatter's system 104 to determine which chat partner is currently selected through iChat™. In some implementations, more than one chat partner may be selected to receive application output. Upon determining that Steve Demo 703 is currently selected, the application component 124 in Chatter's sharing engine 114 can enable the communication engine 110 to forward the application output to Steve Demo over the network 102.

The iChat™ sharing session can also include a live video cast of a chat session. For example, during a chat session with Steve Demo, a live video of Steve Demo can be displayed in the shared screen. As shown in FIG. 7, an image of Steve Demo's head is displayed in real time in a window 712. In some implementations, more than one selected chat partner can be shown in a shared screen. The video in window 712 can be captured by Steve Demo's iChat™ session and forwarded to Chatter as video feed.

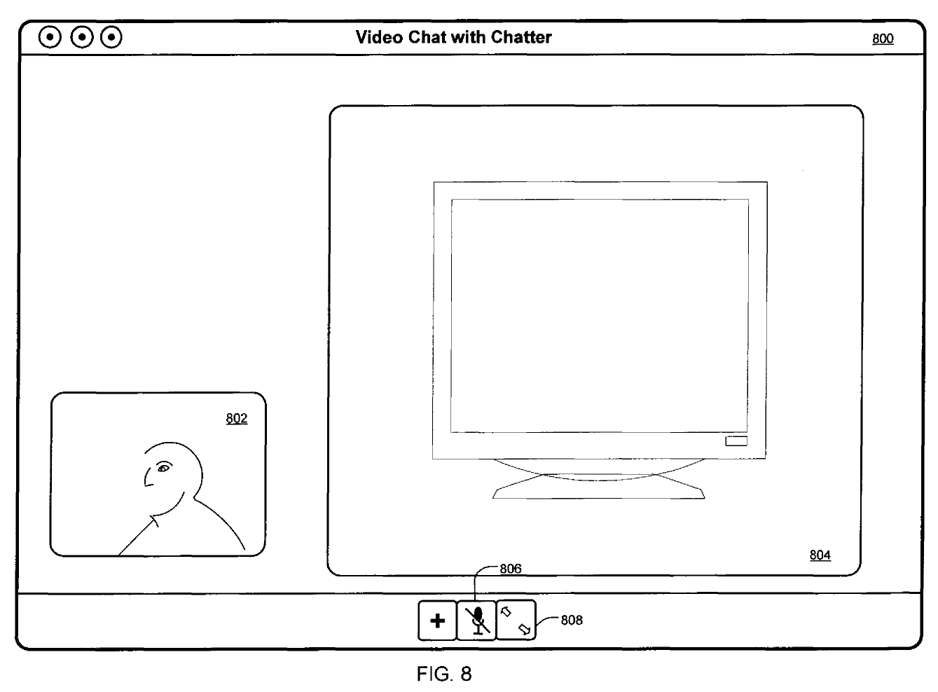

FIG. 8 is a screen shot depicting a user desktop receiving the shared application output of FIG. 7. Here, Steve Demo is viewing his screen 800. The screen 800 can initially be generated by Steve Demo's GUI engine using his own component for display. The screen 800 is titled “Video Chat with Chatter” indicating that a video chat session is in progress with Chatter. Steve Demo currently sees his chat partner Chatter's face in the live video feed 802.

The live video feed 802 can be captured by Chatter's iChat™ and forwarded to Steve Demo as application output. For example, Steve Demo's communication engine receives the video feed of Chatter from Chatter's communication engine 110.

The application output is here video and can be sent through the chat engine. For example, Chatter's application component 124 forwards the application output for receipt by Steve Demo's shared component in Steve Demo's GUI engine. Steve Demo's shared component can then display a picture of the application output on his screen. Thus, Steve Demo is viewing Chatter on the shared screen 800 along with an application program output 804 from Chatter's system.

The screen 800 can include screen configuration options such as a sound control 806 and a full screen mode control 808. The sound control 806 can be used to mute and un-mute the microphone during the chat session. For example, Steve Demo may wish to change the volume of Chatter's voice in the video feed 802. Alternatively, the sound control 806 can be used to configure the sound of the shared application program output 804. The full screen mode control 808 can be used to put the window in a full screen mode wherein the video feed window 802 and the application program output 804 are still visible.

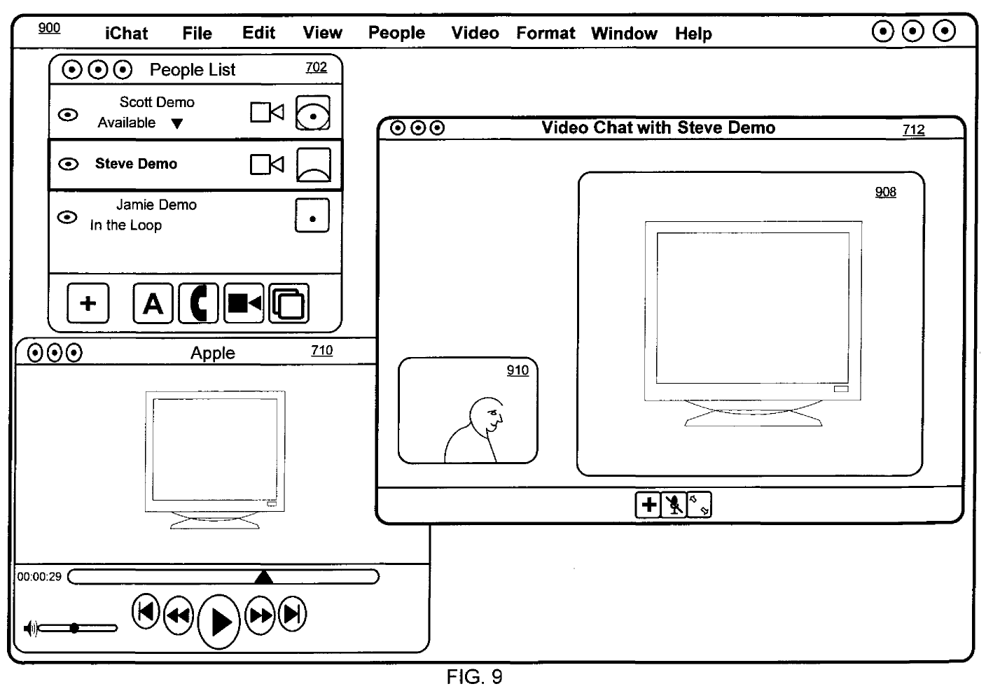

FIG. 9 is a screen shot depicting a sharing session on the desktop user interface 900 from which the sharing in FIG. 8 was initiated. The desktop 900 shows Chatter's screen during the sharing session of FIG. 8. Chatter has an application program 710, an iChat™ program 702 and a video chat window 712 running in the desktop 900. In the video chat window 712, Chatter can view his application program's output 908 that is fed to Steve Demo's system 106. Additionally, Chatter can view a live feed 910 of Steve Demo. The live feed 910 can be generated by Steve Demo's iChat™ application and transmitted to Steve Demo's sharing engine. Steve Demo's sharing engine can transmit the live feed 910 to the application component, which may transmit the live feed 910 to Chatter's communication component 110. The live feed 910 can then be presented in Chatter's video chat window 712.

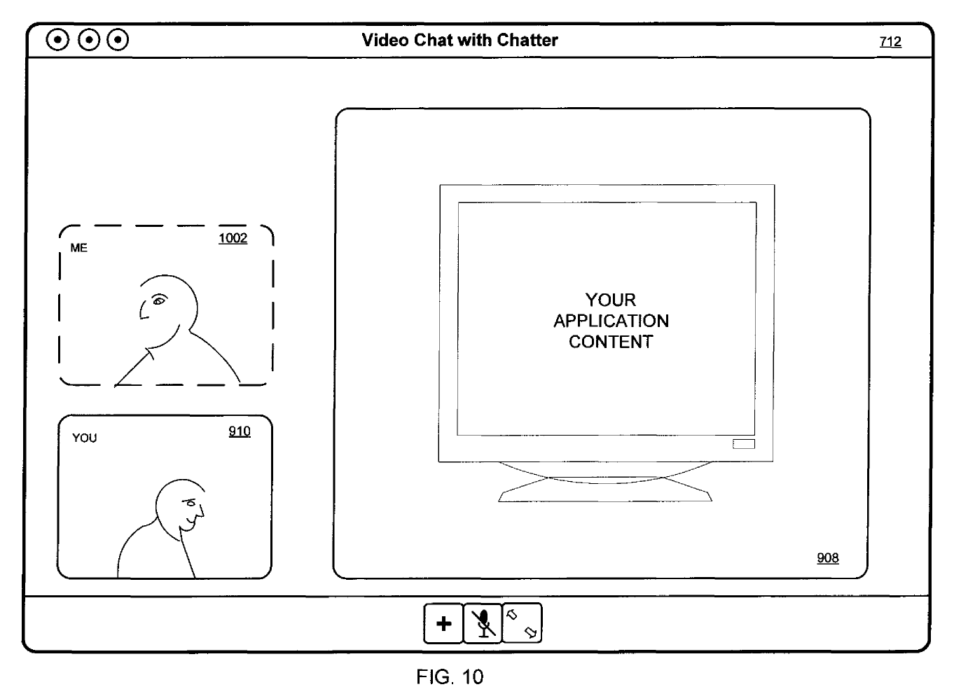

Some examples of screen layouts that can be used in a sharing session are shown in FIGS. 10-13. In these examples, the sharing session involves Chatter sharing application content with Steve Demo. This is in contrast to the previous example, where it was Steve Demo's content that was being shared. For clarity, some content in these illustrations are labeled “me,” “you” and “your content,” respectively. In this nomenclature, “your content” refers to the content being shared as it appears on the recipient's screen, “you” refers to the entity sharing the content, and “me” refers to the entity receiving the shared content. Thus, “me” in this example is Steve Demo, “you” is Chatter, and “your content” is the application program that Chatter is sharing with Steve Demo.

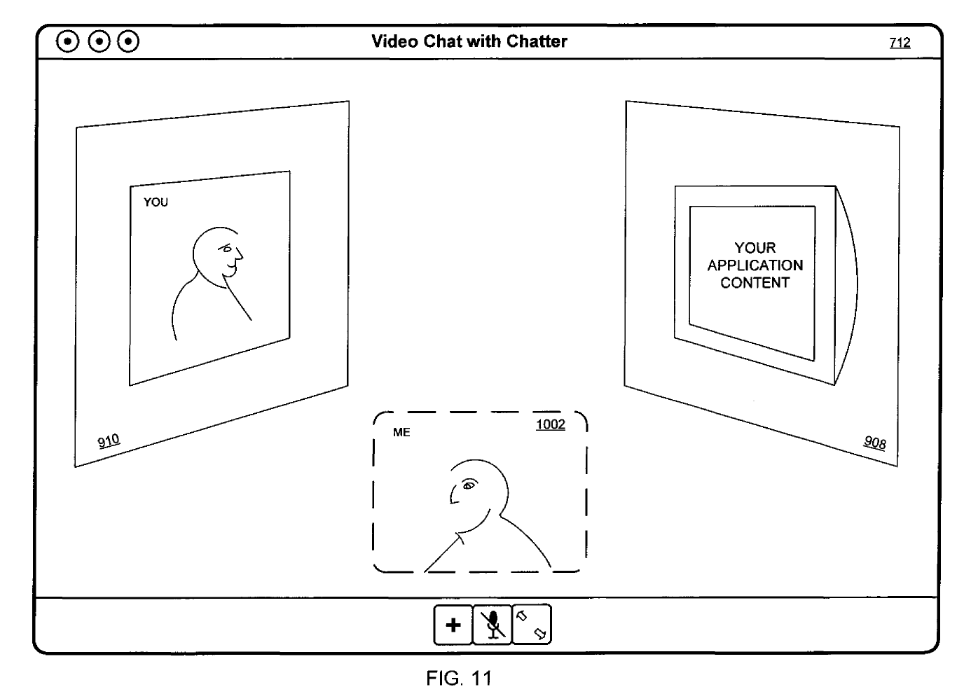

Referring first to FIG. 10, this is a screen that can be presented to Steve Demo during a chat session with Chatter. Application content 908 (here labeled “YOUR APPLICATION CONTENT”) and a live feed 910 (here labeled “YOU”) can be displayed in the window 712 in a variety of modes. For example, the application content 908 and the live feed 910 can be minimized, maximized, resized or generally moved in any direction in the window 712. FIG. 10 shows an example of a first mode of display for sharing application output with another user in which “your application content” 908 is presented on the right hand side of the screen 712, the video feed 910 of Steve Demo is shown next to the content 908, and a live feed 1002 of Steve Demo can also be displayed above Steve Demo's video feed 910. The image of himself that Steve Demo sees can also be displayed on Chatter's screen. The windows for the content 908 and the video feeds 910 and 1002 are here displayed “flat” on the screen; that is, they do not appear tilted to a user. In contrast, FIG. 11 is a screen shot showing an example of a second mode of display wherein one or more windows can appear tilted to the user. The second mode of display shows Chatter's video feed 910 and “your application content” 908 in tilted windows. Thus, the view can be manipulated so that it appears angled inward, as shown, to save space on the desktop 712. For example, a tilted window can give the user the impression of looking at a movie screen from an angle. Other ways of tilting or skewing the images can be used.

Windows can be stacked or tiled in the tilted position and can be moved anywhere on the desktop 712. For example, Steve Demo could minimize Chatter's video feed 910 and maximize “your application content” 908. In addition, the tilted effect can be turned off or on with any or all windows in the desktop 712. For example, Steve Demo's video feed 1002 is shown from a front perspective without tilt.

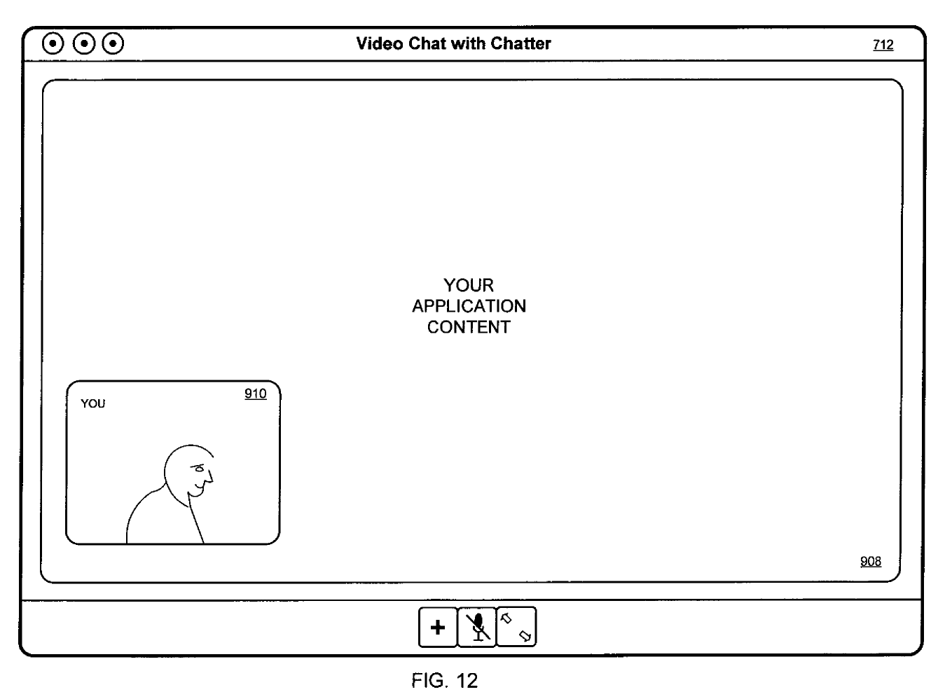

FIG. 12 is a screen shot showing an example of a third mode of display for sharing application output with another user. The third mode of display shows “your application content” 908 maximized in the desktop 712. In some implementations, application content 908 is a full screen view. Chatter's video feed 910 is embedded in your application content 908, but can be moved anywhere within the desktop 712.

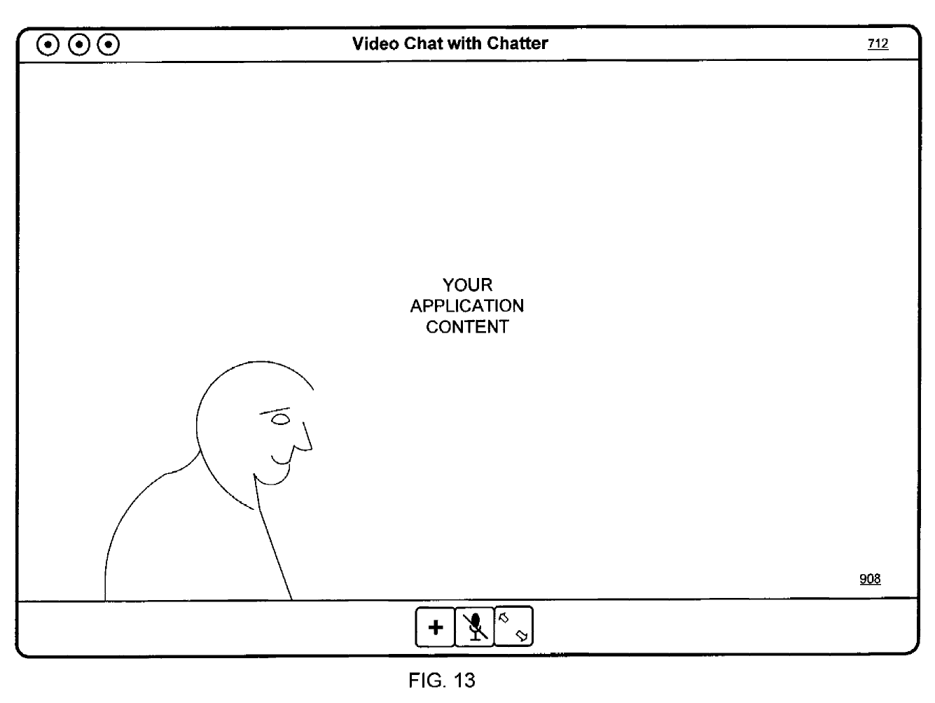

FIG. 13 is a screen shot showing an example of a fourth mode of display for sharing application output with another user. The fourth mode of display shows “your application content” 908 maximized to become the desktop background. Chatter's video feed 910 has been modified to contain only Chatter and not the entire background taken by the video camera pointed at Chatter. For example, Chatter's outline figure has been removed from the video box and embedded in your application content 908. Other display modes can be used.

In the above description, for purposes of explanation, numerous specific details are set forth in order to provide a thorough understanding. It will be apparent, however, to one skilled in the art that implementations can be practiced without these specific details. In other instances, structures and devices are shown in block diagram form in order to avoid obscuring the disclosure.

In particular, one skilled in the art will recognize that other architectures and graphics environments may be used, and that the examples can be implemented using graphics tools and products other than those described above. In particular, the client/server approach is merely one example of an architecture for providing the functionality described herein; one skilled in the art will recognize that other, non-client/server approaches can also be used. Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An apparatus for performing the operations herein may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the method steps. The required structure for a variety of these systems will appear from the description. In addition, the present examples are not described with reference to any particular programming language. It will be appreciated that a variety of programming languages may be used to implement the teachings as described herein. Furthermore, as will be apparent to one of ordinary skill in the relevant art, the modules, features, attributes, methodologies, and other aspects can be implemented as software, hardware, firmware or any combination of the three. Of course, wherever a component is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present description is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A computer-implemented method for sharing content, the method comprising:
receiving at a first device a user input requesting that contents of a graphical user interface be shared, the user input being made in a chat environment including the first device;
determining, in response to the user input, at least one chat identity of an entity registered in the chat environment; and
forwarding, using the determined chat identity, an invitation to the entity's device regarding sharing the contents of the graphical user interface, the invitation being generated from the user input.

2. The computer-implemented method of claim 1, wherein if the entity accepts the invitation, further comprising performing the sharing of the contents of the graphical user interface.

3. The computer-implemented method of claim 2, wherein the contents of the graphical user interface are from the first device and the user input requests that the contents be shared with the entity, and wherein performing the sharing comprises forwarding the contents of the graphical user interface from the first device to the entity's device upon acceptance of the invitation.

4. The computer-implemented method of claim 3, wherein the contents of the graphical user interface include at least one input control, further comprising performing an operation in or on the first device upon receiving a command from the entity's device, the command being generated using the input control.

5. The computer-implemented method of claim 2, wherein the contents of the graphical user interface originate from the entity's device and the user input requests that the entity share the contents, and wherein performing the sharing comprises receiving the contents of the graphical user interface from the entity's device upon acceptance of the invitation, and presenting the contents in the first device.

6. The computer-implemented method of claim 5, wherein the contents of the graphical user interface include at least one input control, further comprising receiving an input in the first device made using the input control, and forwarding a command based on the input to the entity's device for performing an operation in or on the entity's device.

7. The computer-implemented method of claim 5, further comprising presenting in the first device an input control for selectively alternating the first device between presenting: A) the contents received from the entity's device; and B) graphical user contents not received from the entity's device.

8. The computer-implemented method of claim 1, wherein the entity is identified, for forwarding the invitation, from a contact list associated with the chat environment.

9. The computer-implemented method of claim 8, wherein the entity is currently participating in a chat session when the user input is received, and wherein the identification is based on the chat session.

10. The computer-implemented method of claim 8, wherein a user selection of the entity from the contact list is made in connection with the user input.

11. A computer program product tangibly embodied in an information carrier and comprising instructions that when executed by a processor perform a method for sharing content, the method comprising:
receiving at a first device a user input requesting that contents of a graphical user interface be shared, the user input being made in a chat environment including the first device;
determining, in response to the user input, at least one chat identity of an entity registered in the chat environment; and
forwarding, using the determined chat identity, an invitation to the entity's device regarding sharing the contents of the graphical user interface, the invitation being generated from the user input.

12. A computer-implemented method for sharing content, the method comprising:
receiving, in a first device associated with a first entity, graphical user interface contents shared from a second device associated with a second entity, the first entity having been identified in a chat environment for receiving the shared graphical user interface contents;
presenting the shared graphical user interface contents in the first device after the receipt; and
presenting, in the first device, a first input control for selectively alternating the first device between presenting: A) the shared graphical user interface contents; and B) graphical user contents not received from the second device.

13. The computer-implemented method of claim 12, wherein the shared graphical user interface contents are received after the first device accepts an invitation from the second device to receive the contents.

14. The computer-implemented method of claim 12, wherein the shared graphical user interface contents are received after the second device accepts an invitation from the first device to share the contents.

15. The computer-implemented method of claim 12, wherein the contents are shared during a chat session.

16. The computer-implemented method of claim 12, wherein the shared graphical user interface contents include at least a second input control, further comprising receiving an input in the first device made using the second input control, and forwarding a command based on the input to the second device for performing an operation in or on the second device.

17. A computer program product tangibly embodied in an information carrier and comprising instructions that when executed by a processor perform a method for sharing content, the method comprising:
receiving, in a first device associated with a first entity, graphical user interface contents shared from a second device associated with a second entity, the first entity having been identified in a chat environment for receiving the shared graphical user interface contents;
presenting the shared graphical user interface contents in the first device after the receipt; and
presenting, in the first device, a first input control for selectively alternating the first device between presenting: A) the shared graphical user interface contents; and B) graphical user contents not received from the second device.

18. A computer program product tangibly embodied in an information carrier, the computer program product including instructions that, when executed, generate on a display device a graphical user interface for sharing content, the graphical user interface comprising:
a content area presenting shared graphical user interface contents, the graphical user interface being generated in a first device associated with a first entity and the graphical user interface contents being shared from a second device associated with a second entity, the first entity having been identified in a chat environment for receiving the shared graphical user interface contents; and
a first input control for selectively alternating the first device between presenting in the content area: A) the shared graphical user interface contents; and B) graphical user contents not shared from the second device.

19. The computer program product of claim 18, wherein the shared graphical user interface contents include at least a second input control, and wherein an input can be made in the first device using the second input control for performing an operation in or on the second device.
